(19) United States
(12) Patent Application Publication
(10) Pub. No.: US 2017/0162336 A1
(43) Pub. Date: Jun. 8, 2017

(54) SOLID ELECTROLYTIC CAPACITOR

(71) Applicant: NEC TOKIN Corporation, Sendai-shi (JP)

(72) Inventor: Hiroki SATO, Sendai-shi (JP)

(21) Appl. No.: 15/345,321

(22) Filed: Nov. 7, 2016

(30) Foreign Application Priority Data
Dec. 4, 2015 (JP) 2015-237439

(51) Int. Cl. H01G 9/025; C08K 3/22; H01G 9/012; H01G 9/15; H01G 9/07

(52) U.S. Cl. CPC H01G 9/025; H01G 9/15; H01G 9/07; H01G 9/012; C08K 3/22; C08K 2003/2296; C08K 2201/001

(57) ABSTRACT

A solid electrolytic capacitor according to the present invention includes: an anode body; a dielectric layer arranged on a surface of the anode body; and a solid electrolyte layer arranged on a surface of the dielectric layer and formed using zinc oxide having a conductivity of 1 (S/cm) or more. Further, in the solid electrolytic capacitor according to the present invention, a diffusion suppressing layer to suppress a mutual diffusion between the dielectric layer and the solid electrolyte layer may be formed between the dielectric layer and the solid electrolyte layer.

### CROSS REFERENCE TO RELATED APPLICATIONS

The present application claims priority to Japanese patent application No. 2015-237439, filed on Dec. 4, 2015. The entire contents of the above-referenced application are hereby incorporated by reference for all purposes.

### BACKGROUND OF THE INVENTION

Field of the Invention

The present invention relates to a solid electrolytic capacitor and more specifically, to a solid electrolytic capacitor that uses a conductive zinc oxide for an electrolyte.

Description of Related Art

In general, an electrolytic solution including an organic solvent having a low molecular weight such as ethylene glycol or γ-butyrolactone as a main component and containing an electrolyte such as an adipic acid, a sebacic acid, a boric acid, a phosphoric acid or a salt thereof dissolved therein is used as an electrolyte of an electrolytic capacitor. As other electrolytes, a conductive polymer that uses polythiophene, polypyrrole, polyaniline or its derivatives, manganese dioxide and the like are used.

Japanese Unexamined Patent Application Publication No. 4-240710 discloses a technique that relates to a method of forming a solid electrolyte that is placed adjacent to a dielectric film formed in an anode body of valve metal.

### SUMMARY OF THE INVENTION

In recent years, when an electrolytic capacitor is used on a vehicle, for example, it is required to increase the temperature at which the electrolytic capacitor can be used. However, the organic material such as the electrolytic solution of the electrolytic capacitor or the conductive polymer volatilizes or decomposes at high temperatures, which causes a reduction in the function of the capacitor.

The above problem can be solved by using manganese dioxide as the electrolyte. This causes a problem, however, that an equivalent series resistance (ESR) of the capacitor becomes high since manganese dioxide has a low conductivity.

In view of the aforementioned problem, an object of the present invention is to provide a solid electrolytic capacitor having heat resistance and low ESR characteristics.

A solid electrolytic capacitor according to the present invention includes: an anode body; a dielectric layer arranged on a surface of the anode body; and a solid electrolyte layer arranged on a surface of the dielectric layer and formed using zinc oxide having a conductivity of 1 (S/cm) or more.

According to the present invention, it is possible to provide a solid electrolytic capacitor having heat resistance and low ESR characteristics.

The above and other objects, features and advantages of the present invention will become more fully understood from the detailed description given hereinbelow and the accompanying drawings which are given by way of illustration only, and thus are not to be considered as limiting the present invention.

### BRIEF DESCRIPTION OF THE DRAWINGS

FIG. 1 is a cross-sectional view showing a solid electrolytic capacitor according to a first embodiment;

FIG. 2 is a cross-sectional view showing a solid electrolytic capacitor according to a second embodiment;

FIG. 3 is a table showing an electrolyte, a conductivity of the electrolyte, a diffusion suppressing layer, a capacity (120 Hz), a capacity (100 kHz), and a leakage current percent defective in Examples 1 to 21; and

FIG. 4 is a table showing an electrolyte, a conductivity of the electrolyte, a diffusion suppressing layer, a capacity (120 Hz), a capacity (100 kHz), and a leakage current percent defective in Examples 22 to 42.

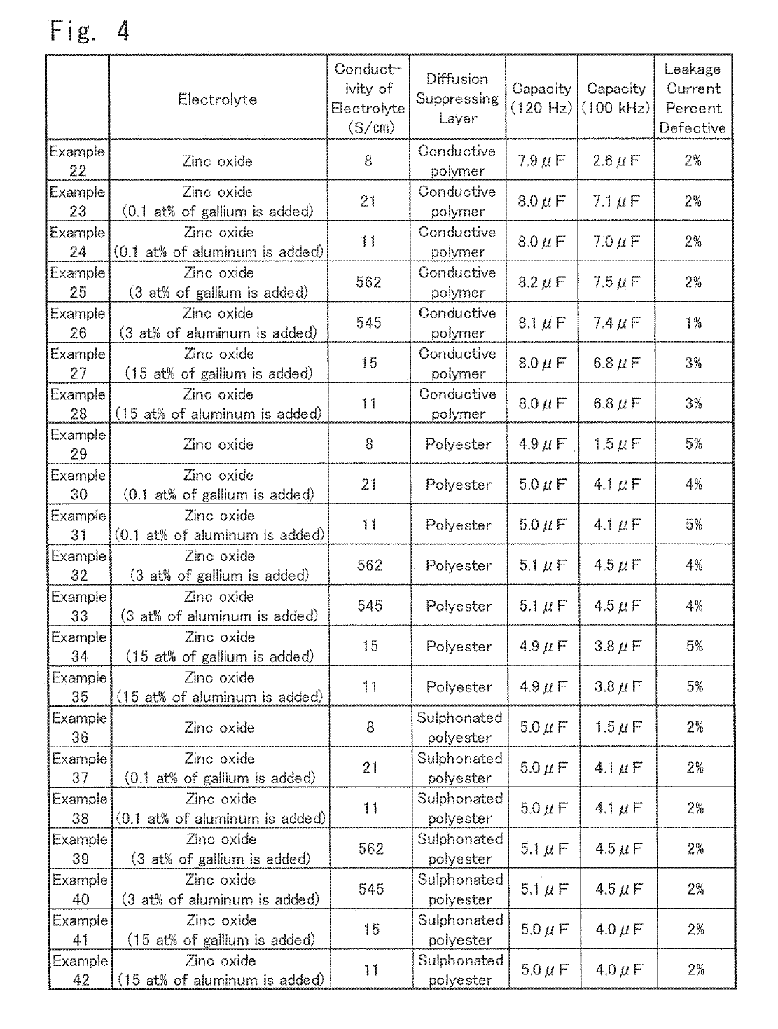

### DESCRIPTION OF THE EXEMPLARY EMBODIMENTS

### First Embodiment

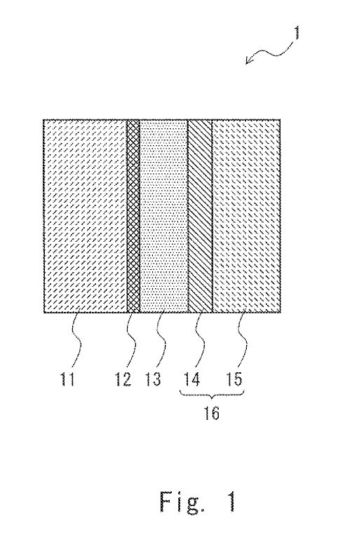

Hereinafter, with reference to the drawings, embodiments of the present invention will be described. FIG. 1 is a cross-sectional view showing a solid electrolytic capacitor according to a first embodiment. As shown in FIG. 1, a solid electrolytic capacitor 1 according to this embodiment includes an anode body 11, a dielectric layer 12 that is arranged on a surface of the anode body 11, a solid electrolyte layer 13 formed on a surface of the dielectric layer 12, and a cathode body 16. The cathode body 16 includes a graphite layer 14 and a silver layer 15 and functions as a cathode extraction layer that connects the solid electrolyte layer 13 and a cathode (not shown).

The anode body 11 is formed using valve metal. The valve metal may be, for example, aluminum, tantalum, niobium, titanium, zirconium, hafnium, tungsten, and alloys including the same. These materials of the valve metal are merely examples and any material may be used in the solid electrolytic capacitor according to this embodiment as long as the use of the material causes a rectifying effect between the dielectric layer formed on the anode body 11 and a conductive zinc oxide electrolyte.

The dielectric layer 12 may be formed, for example, by anodizing the anode body 11, which is the valve metal. When aluminum is used for the anode body 11, an aluminum oxide film (the dielectric layer 12) may be formed on a surface of the anode body 11 by anodizing the anode body 11. The thickness of the dielectric layer 12 is, for example, about 1 nm to 2 μm.

The solid electrolyte layer 13 is formed between the dielectric layer 12 and the cathode body 16. While the thickness of the solid electrolyte layer 13 is not particularly limited as long as an electric conductivity can be secured, the rectifying effect appears, and the capacity can be drawn out, the thickness of the solid electrolyte layer 13 is, for example, about 10 nm to 500 μm. The details of the solid electrolyte layer 13 will be described later.

The graphite layer 14 is formed on a surface of the solid electrolyte 13. The graphite layer 14 is formed, for example, using carbon paste (e.g., formed of carbon particles, graphite, and resin). The graphite layer 14 is formed on the solid electrolyte layer 13 so that the graphite layer 14 is in direct contact with the solid electrolyte layer 13. The silver layer 15 is formed on a surface of the graphite layer 14. The silver paste layer 15 can be formed, for example, by mixing silver particles and an epoxy resin. The thickness of the graphite layer 14 is, for example, about 10 nm to 100 μm and the thickness of the silver paste layer 15 is, for example, about 1 μm to 300 μm.

The cathode body (cathode extraction layer) 16 may be formed, using only one of the graphite layer 14 and the silver layer 15. That is, the cathode body (cathode extraction layer) 16 may have a desired structure as long as the solid electrolyte layer 13 and the cathode (not shown) can be electrically connected to each other.

The solid electrolytic capacitor 1 according to this embodiment is formed using zinc oxide having a conductivity as the solid electrolyte layer 13. In the following description, the solid electrolyte layer 13 included in the solid electrolytic capacitor 1 according to this embodiment will be described in detail.

It is required that the rectifying effect appear between the solid electrolyte layer 13 and the dielectric layer 12 of the solid electrolytic capacitor 1 in order to accumulate electric charge in the dielectric layer 12. While zinc oxide (ZnO) is an insulating material, zinc oxide (ZnO) can be made conductive by adding a dopant or forming an oxygen deficiency. While the type of the dopant is not limited as long as the conductivity can be increased and the rectifying effect appears, the dopant may be, for example, a Group 3 element (e.g., Sc or Y), a Group 4 element (Ti, Zr, or Hf), a Group 13 element (e.g., B, Al, Ga, or In), a Group 14 element (e.g., Si, Ge, or Sn), V (vanadium), or F (fluorine). In view of conductivity, B (boron), Al (aluminum), or Ga (gallium) is preferably used. It is the first time that the rectifying effect has appeared between the conductive zinc oxide and the dielectric layer and electrical storage has been confirmed with the use of the conductive zinc oxide having a conductivity of 1 S/cm or more that uses the oxygen deficiency or the conductive zinc oxide that contains the dopant.

Incidentally, the conductive zinc oxide formed by doping with a dopant has a heat resistance higher than that of zinc oxide which is made conductive due to an oxygen deficiency. That is, the conductive zinc oxide formed by doping with a dopant is a material having a high conductivity and a high heat resistance and is a material in which the rectifying effect appears when the conductive zinc oxide is formed on the dielectric layer 12. The zinc oxide which is made conductive due to the oxygen deficiency has a sufficiently high heat resistance to accomplish the object of the present invention.

Further, it may be possible to prevent oxygen from entering the conductive zinc oxide used for the electrolyte in order to further improve the heat resistance. The conductive zinc oxide may be, for example, coated with a molding agent, plated, or sealed, or the graphite layer or the silver layer may contain a substance through which hardly any oxygen can pass or a substance that captures oxygen.

The solid electrolyte layer 13 can be formed, for example, by a sputtering method, an ion plating method, a vapor deposition method, a plating method, a liquid phase deposition method, a method of attaching powders dispersed into a solution or the like. When the shape of the dielectric layer 12 is a shape that is formed by etching or is a shape having large irregularities such as a powder-sintered body, for example, it is required to form the electrolyte deep in the irregularities of the dielectric layer 12 to draw out the capacity. In this case, the solid electrolyte layer 13 is preferably formed using, for example, a method such as the vapor deposition method, the plating method, or the liquid phase deposition method by which the irregularities can be impregnated with the electrolyte deeply.

The solid electrolyte layer 13 may be formed at a high temperature (e.g., about 300° C.) or at room temperature. Further, when the solid electrolyte layer 13 is formed, zinc oxide may be formed while heating the anode body 11 after the dielectric layer 12 is formed or an annealing processing may be performed in order to improve the conductivity of zinc oxide after the zinc oxide is formed.

The solid electrolyte layer 13 may be formed either in the air or in an inert gas. When the oxygen deficiency is formed in zinc oxide, the solid electrolyte layer 13 is preferably formed in an inert gas or in a slightly reducing atmosphere. Argon, helium, nitrogen gas or the like may be used as the inert gas. Hydrogen or the like may be used in a reducing atmosphere. Further, after the solid electrolyte layer 13 is formed, zinc oxide may be reduced using hydrogen gas or the like. As one example, after zinc oxide is formed, zinc oxide may be processed under a hydrogen gas atmosphere, whereby the oxygen deficiency may be formed in the zinc oxide.

In this embodiment, zinc oxide, which is the solid electrolyte layer 13, has a conductivity of 1 (S/cm) or more, more preferably a conductivity of 10 (S/cm) or more, and still more preferably a conductivity of 50 (S/cm) or more. The conductivity can be adjusted by controlling the atmosphere, the time, and the temperature before and after the formation of the zinc oxide. Alternatively, the conductivity can be adjusted by adjusting the dopant concentration. In one more alternative, the conductivity can be adjusted by using both of above means.

In this embodiment, zinc oxide, which is the solid electrolyte layer 13, may contain 0.01 to 20 at % of dopant including at least one of B, Al, and Ga. In this case, the conductivity of zinc oxide may be made 5 (S/cm) or more. It is sufficient that the dopant be eventually received by the zinc oxide solid electrolyte. The dopant may be, for example, mixed before the formation of the zinc oxide, made to coexist at the time of the formation, or diffused and received after the formation of the zinc oxide.

Further, in this embodiment, zinc oxide, which is the solid electrolyte layer 13, may include 0.1 to 15.0 at % of Al, which is the dopant. In this case, the conductivity of zinc oxide may be made 10 (S/cm) or more.

Further, in this embodiment, zinc oxide, which is the solid electrolyte layer 13, may include 0.1 to 15.0 at % of Ga, which is the dopant. In this case, the conductivity of zinc oxide may be made 10 (S/cm) or more.

Further, in this embodiment, zinc oxide, which is the solid electrolyte layer 13, may be made conductive by forming the oxygen deficiency.

As described above, the solid electrolytic capacitor according to this embodiment is formed using the solid electrolyte (inorganic material) for the electrolyte. Accordingly, the heat resistance of the solid electrolytic capacitor can be improved more than in the case in which the electrolyte is formed of an organic material such as a conductive polymer. Further, in the solid electrolytic capacitor according to this embodiment, the solid electrolyte layer is formed using zinc oxide having a conductivity of 1 (S/cm) or more. Accordingly, the ESR characteristics of the solid electrolytic capacitor can be improved (that is, the ESR characteristics can be made low) more than in the case in which the solid electrolyte layer is formed using manganese dioxide having a low conductivity. Further, the reduction in the ESR allows low loss of capacity in a high frequency side as well.

As described above, according to the invention described in this embodiment, it is possible to provide a solid electrolytic capacitor having heat resistance and low ESR characteristics.

In this embodiment, the material of the solid electrolyte layer 13 may be any material as long as it is possible to deposit the solid electrolyte layer 13 on the dielectric layer 12. A simple substance, an oxide, or a compound or the like including the target constituent element, for example, may be used. Alternatively, a mixture thereof may be used. When the solid electrolyte layer 13 includes two or more types of elements, a material into which these elements are mixed in advance may be used.

Further, the solid electrolyte layer 13 may either be one layer or multiple layers. When the solid electrolyte layer 13 is formed of only zinc oxide, the solid electrolyte layer 13 may have a two-layer structure in which an inner side (a side of the dielectric layer 12) is formed by the liquid phase deposition method and an outer side of the solid electrolyte layer 13 is formed by the vapor deposition method or the sputtering method.

### Second Embodiment

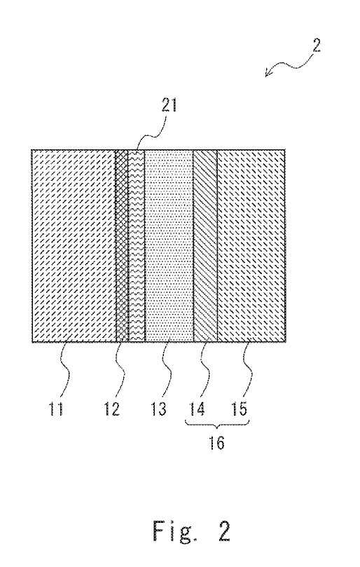

Next, a second embodiment of the present invention will be described. FIG. 2 is a cross-sectional view showing a solid electrolytic capacitor according to the second embodiment. A solid electrolytic capacitor 2 according to this embodiment is different from the solid electrolytic capacitor 1 described in the first embodiment in that a diffusion suppressing layer 21 is formed between the dielectric layer 12 and the solid electrolyte layer 13. Since the other components of the solid electrolytic capacitor 2 according to the second embodiment are similar to/the same as those of the solid electrolytic capacitor 1 according to the first embodiment, such similar/the same components are denoted by the same reference symbols and overlapping descriptions will be omitted.

As shown in FIG. 2, the solid electrolytic capacitor 2 according to this embodiment includes the diffusion suppressing layer 21 that is formed between the dielectric layer 12 and the solid electrolyte layer 13. The diffusion suppressing layer 21 includes a function of suppressing a mutual diffusion between the dielectric layer 12 and the solid electrolyte layer 13. The diffusion suppressing layer 21 may be formed of, for example, silicon (Si), silicone (a compound containing silicon), a conductive polymer, manganese dioxide, or resin.

When a material such as silicon, silicone, or resin that has no conductivity is used as the material of the diffusion suppressing layer 21, the thickness of the diffusion suppressing layer 21 is preferably made as small as possible (e.g., 1 μm or smaller). When the thickness of the diffusion suppressing layer 21 is larger than 1 μm, this may cause a decrease in the capacity of the solid electrolytic capacitor or an increase in the ESR characteristics. Further, when the solid electrolyte layer 13 is formed under a high temperature, silicon, silicone, or manganese dioxide, which has heat resistance, is preferably used as the material of the diffusion suppressing layer 21. Further, when resin is used for the diffusion suppressing layer 21, the diffusion suppressing layer 21 is preferably formed using resin having a sulfo group, a carboxy group, or a hydroxy group from the viewpoint of repairing the dielectric layer 12 (oxide film). The diffusion suppressing layer 21 may be formed, for example, by a repetition of immersing and drying of a solution including the material of the diffusion suppressing layer 21 after the dielectric layer 12 is formed on the surface of the anode body 11.

When resin is used as the material of the diffusion suppressing layer 21, the following materials may be used: polyvinyl alcohol, polyvinyl acetate, polycarbonate, polyacrylate, polymethacrylate, polystyrene, polyurethane, polyacrylonitrile, polybutadiene, polyisoprene, polyether, polyester, polyethylene terephthalate, polybutylene terephthalate, polyamide, polyimide, butyral resin, melamine resin, alkyd resin, cellulose, nitrocellulose, bisphenol A type epoxy, bisphenol F type epoxy, cycloaliphatic epoxy, a modified product thereof or the like. These materials are merely examples and any other resins may be used as long as the material allows the formation of the thin diffusion suppressing layer 21 on the surface of the dielectric layer 12. When it is required to form the diffusion suppressing layer 21 inside fine pores such as in a case in which the powder-sintered body is used, a material that can be dissolved is preferably used. Further, these resins may be obtained by reacting an original monomer or oligomer on the dielectric layer.

In the solid electrolytic capacitor 2 according to this embodiment, the diffusion suppressing layer 21 is formed between the dielectric layer 12 and the solid electrolyte layer 13 in order to suppress the diffusion between the dielectric layer 12 and the solid electrolyte layer 13. Accordingly, it is possible to suppress diffusion of zinc, dopant or the like from the solid electrolyte to the dielectric body or diffusion of Ta, Al or the like from the dielectric body to the solid electrolyte between the dielectric layer 12 and the solid electrolyte layer 13, or degradation of the solid electrolytic capacitor 2 by the mutual diffusion between the dielectric body and the solid electrolyte when the solid electrolytic capacitor 2 is used under a high temperature. The “diffusion” defined here means an atomic diffusion.

Further, in the solid electrolytic capacitor 2 according to this embodiment, the conductive polymer or resin can be used for the material of the diffusion suppressing layer 21. That is, since the thickness of the diffusion suppressing layer 21 is smaller than that of the solid electrolyte layer 13, even when the conductive polymer or the resin is used for the material of the diffusion suppressing layer 21, this has little influence on the heat resistance of the solid electrolytic capacitor.

### EXAMPLES

Next, Examples according to the present invention will be described.

While the present invention will be specifically described based on the Examples, the present invention is not limited to these Examples. While a capacitor having a simple configuration is evaluated in the following Examples, effects similar to those in the following Examples can be expected even in a case in which a powder-sintered body, etched foil or the like is used.

### Example 1

A tantalum plate, which is valve metal, was used for the anode body of the solid electrolytic capacitor. Then the tantalum plate was electrolytic-oxidized in a phosphoric acid aqueous solution with an applied voltage of 100 V to form the dielectric layer (oxide film layer) having a thickness of about 170 nm on the whole surface of the tantalum plate. After that, the solid electrolyte layer formed of the conductive zinc oxide film having a thickness of about 1 μm was formed on a surface of the dielectric layer using the sputtering method. The area of the solid electrolyte layer that was formed was 70 cm². Then the graphite layer (about 1 μm) and the silver paste layer (about 10 μm) were formed on the solid electrolyte layer to obtain the solid electrolytic capacitor according to Example 1.

The capacity of the solid electrolytic capacitor that was produced was measured using an LCR meter. The value of the capacity at 120 Hz and that at 100 kHz were evaluated. Further, the solid electrolytic capacitor that was produced was subjected to a voltage application test of 125° C. (1.0 W.V) for 1,000 hours to determine the percentage defective (evaluated by a leakage current) of the solid electrolytic capacitor when the evaluation of the voltage application test completed. In this case, it was determined that the leakage current value having 0.1 CV or larger (0.1×initial capacity×formation voltage) was not up to standard.

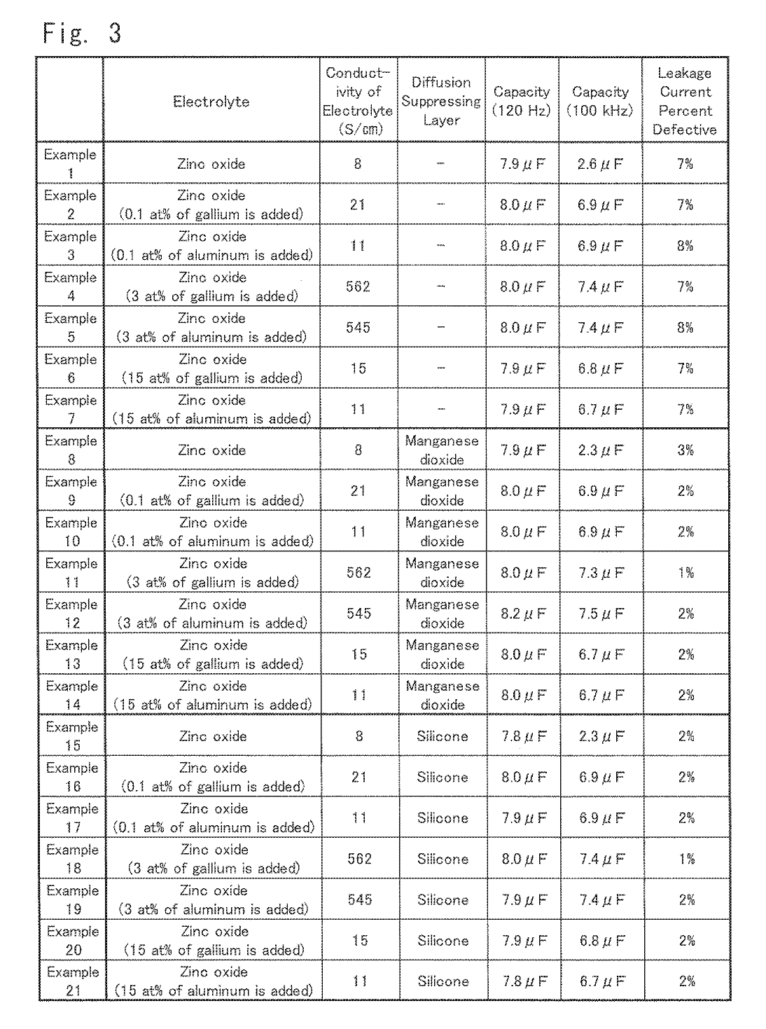

Further, the zinc oxide film was produced on a glass substrate using a method similar to the method of forming the zinc oxide film on a surface of the tantalum plate. Then the conductivity of the zinc oxide film that was produced was calculated using the resistance value that was measured using Loresta GP MCT-T610, manufactured by Mitsubishi Chemical Analytech Co., Ltd., and the thickness of the zinc oxide film. The table shown in FIG. 3 shows the results.

### Example 2

As a solid electrolytic capacitor according to Example 2, a solid electrolytic capacitor that uses zinc oxide to which 0.1 at % of gallium was added as the solid electrolyte layer was produced. The other procedures were similar to those in Example 1.

### Example 3

As a solid electrolytic capacitor according to Example 3, a solid electrolytic capacitor that uses zinc oxide to which 0.1 at % of aluminum was added as the solid electrolyte layer was produced. The other procedures were similar to those in Example 1.

### Example 4

As a solid electrolytic capacitor according to Example 4, a solid electrolytic capacitor that uses zinc oxide to which 3 at % of gallium was added as the solid electrolyte layer was produced. The other procedures were similar to those in Example 1.

### Example 5

As a solid electrolytic capacitor according to Example 5, a solid electrolytic capacitor that uses zinc oxide to which 3 at % of aluminum was added as the solid electrolyte layer was produced. The other procedures were similar to those in Example 1.

### Example 6

As a solid electrolytic capacitor according to Example 6, a solid electrolytic capacitor that uses zinc oxide to which 15 at % of gallium was added as the solid electrolyte layer was produced. The other procedures were similar to those in Example 1.

### Example 7

As a solid electrolytic capacitor according to Example 7, a solid electrolytic capacitor that uses zinc oxide to which 15 at % of aluminum was added as the solid electrolyte layer was produced. The other procedures were similar to those in Example 1.

### Example 8 to 14

As solid electrolytic capacitors according to Examples 8 to 14, a solid electrolytic capacitor including a diffusion suppressing layer (100 nm) made of manganese dioxide formed between the dielectric layer and the solid electrolyte layer was produced. The other procedures were similar to those in Examples 1 to 7. The solid electrolyte layers used in Examples 8 to 14 respectively correspond to the solid electrolyte layers used in Examples 1 to 7.

### Example 15 to 21

As solid electrolytic capacitors according to Examples 15 to 21, a solid electrolytic capacitor including a diffusion suppressing layer (5 nm) made of silicone formed between the dielectric layer and the solid electrolyte layer was produced. The other procedures were similar to those in Examples 1 to 7. The solid electrolyte layers used in Examples 15 to 21 respectively correspond to the solid electrolyte layers used in Examples 1 to 7.

### Example 22 to 28

As solid electrolytic capacitors according to Examples 22 to 28, a solid electrolytic capacitor including a diffusion suppressing layer (100 nm) made of a conductive polymer formed between the dielectric layer and the solid electrolyte layer was produced. The conductive polymer was formed by repeating immersing and drying of polyaniline dissolved into an NMP (N-methyl-2-pyrrolidone) solution. The other procedures were similar to those in Examples 1 to 7. The solid electrolyte layers used in Examples 22 to 28 respectively correspond to the solid electrolyte layers used in Examples 1 to 7.

### Example 29 to 35

As solid electrolytic capacitors according to Examples 29 to 35, a solid electrolyte capacitor including a diffusion suppressing layer (100 nm) made of polyester formed between the dielectric layer and the solid electrolyte layer was formed. The other procedures were similar to those in Examples 1 to 7. The solid electrolyte layers used in Examples 29 to 35 respectively correspond to the solid electrolyte layers used in Examples 1 to 7.

### Example 36 to 42

As solid electrolytic capacitors according to Examples 36 to 42, a solid electrolyte capacitor including a diffusion suppressing layer (100 nm) made of sulphonated polyester formed between the dielectric layer and the solid electrolyte layer was produced. The other procedures were similar to those in Examples 1 to 7. The solid electrolyte layers used in Examples 36 to 42 respectively correspond to the solid electrolyte layers used in Examples 1 to 7

### <Study of Evaluation Results>

Comparing Examples 1 to 7, while the conductivity of the electrolyte was 8 (S/cm) in Example 1 in which the dopant was not added to zinc oxide, the conductivity of the electrolyte was 11 to 545 (S/cm) in Examples 2 to 7 in which the dopant was added to zinc oxide. Accordingly, when the dopant (gallium or aluminum) was added to zinc oxide, which is the electrolyte, the conductivity of the electrolyte was increased. In Examples 4 and 5 in which the amount of the dopant that was added was 3 at %, in particular, the conductivities of the electrolyte were 562 (S/cm) and 545 (S/cm), respectively, which are both high values.

Further, regarding the capacity in 100 kHz, while the capacity was 2.6 (g) in Example 1 in which the dopant was not added to zinc oxide, the capacity was 6.7 to 7.4 (g) in Examples 2 to 7 in which the dopant was added to zinc oxide. Accordingly, when the dopant (gallium or aluminum) was added to zinc oxide, which is the electrolyte, the capacity in 100 kHz was increased. This is due to the charge coming close to the dielectric layer since the resistance of the electrolyte was decreased.

Further, in order to verify the effects of the diffusion suppressing layer, the solid electrolytic capacitor in which manganese dioxide is used for the material of the diffusion suppressing layer (Examples 8 to 14), the solid electrolytic capacitor in which silicone is used for said material (Examples 15 to 21), the solid electrolytic capacitor in which the conductive polymer is used for said material (Examples 22 and 23), the solid electrolytic capacitor in which polyester is used for said material (Examples 29 to 35), and the solid electrolytic capacitor in which sulphonated polyester is used for said material (Examples 36 to 42) were produced. At this time, a sample that uses zinc oxide for the solid electrolyte layer, a sample that uses zinc oxide to which gallium was added for the solid electrolyte layer, and a sample that uses zinc oxide to which aluminum was added for the solid electrolyte layer were produced for the comparison of Examples 8 to 42 with Examples 1 to 7.

From the comparison of Examples 1 to 7 with Examples 8 to 42, it is seen that the leakage current percent defective was reduced when the diffusion suppressing layer was formed (Examples 8 to 42) compared to the case in which the diffusion suppressing layer was not formed (Examples 1 to 7). Specifically, while the leakage current percent defective when the diffusion suppressing layer was not formed (Examples 1 to 7) was 7 to 8%, the leakage current percent defective was low (1 to 5%) when the diffusion suppressing layer was formed (Examples 8 to 42). When silicone was used (Examples 15 to 21) and sulphonated polyester was used (Examples 36 to 42) for the diffusion suppressing layer, in particular, the leakage current percent defective was 1% to 2%, which means excellent characteristics were obtained.

From the invention thus described, it will be obvious that the embodiments of the invention may be varied in many ways. Such variations are not to be regarded as a departure from the spirit and scope of the invention, and all such modifications as would be obvious to one skilled in the art are intended for inclusion within the scope of the following claims.

1. A solid electrolytic capacitor comprising:
an anode body;
a dielectric layer arranged on a surface of the anode body; and
a solid electrolyte layer arranged on a surface of the dielectric layer and formed using zinc oxide having a conductivity of 1 (S/cm) or more.

2. The solid electrolytic capacitor according to claim 1, wherein the zinc oxide contains at least one dopant.

3. The solid electrolytic capacitor according to claim 2, wherein the dopant contains at least one of B, Al, and Ga.

4. The solid electrolytic capacitor according to claim 2, wherein the amount of the dopant that is added is within a range from 0.01 to 20 at %.

5. The solid electrolytic capacitor according to claim 4, wherein the conductivity of the zinc oxide is 5 (S/cm) or more.

6. The solid electrolytic capacitor according to claim 2, wherein the zinc oxide contains 0.1 to 15.0 at % of Al as the dopant.

7. The solid electrolytic capacitor according to claim 2, wherein the zinc oxide contains 0.1 to 15.0 at % of Ga as the dopant.

8. The solid electrolytic capacitor according to claim 6, wherein the conductivity of the zinc oxide is 10 (S/cm) or more.

9. The solid electrolytic capacitor according to claim 7, wherein the conductivity of the zinc oxide is 10 (S/cm) or more.

10. The solid electrolytic capacitor according to claim 1, wherein the zinc oxide forms an oxygen deficiency so that the zinc oxide is made conductive.

11. The solid electrolytic capacitor according to claim 1, wherein a diffusion suppressing layer to suppress a mutual diffusion between the dielectric layer and the solid electrolyte layer is formed between the dielectric layer and the solid electrolyte layer.

12. The solid electrolytic capacitor according to claim 2, wherein a diffusion suppressing layer to suppress a mutual diffusion between the dielectric layer and the solid electrolyte layer is formed between the dielectric layer and the solid electrolyte layer.

13. The solid electrolytic capacitor according to claim 11, wherein the diffusion suppressing layer is formed of silicon, silicone, a conductive polymer, manganese dioxide, or resin.

14. The solid electrolytic capacitor according to claim 12, wherein the diffusion suppressing layer is formed of silicon, silicone, a conductive polymer, manganese dioxide, or resin.

15. The solid electrolytic capacitor according to claim 11, wherein the diffusion suppressing layer is formed of resin including a sulfo group, a carboxy group, or a hydroxy group.

16. The solid electrolytic capacitor according to claim 12, wherein the diffusion suppressing layer is formed of resin including a sulfo group, a carboxy group, or a hydroxy group.
